(19) United States
(12) Patent Application Publication
(10) Pub. No.: US 2026/0349769 A1
(43) Pub. Date: Nov. 5, 2026

(54) SYSTEMS AND METHODS FOR AUTONOMOUS DATA MAPPING DURING CODE DEVELOPMENT

(71) Applicant: Fidelity Information Services, LLC, Jacksonville, FL (US)

(72) Inventor: Ranadhir GHOSH, St. Johns, FL (US)

(73) Assignee: Fidelity Information Services, LLC, Jacksonville, FL (US)

(21) Appl. No.: 19/194,216

(22) Filed: Apr. 30, 2025

(51) Int. Cl. G06F 9/451; G06F 8/70; G06F 40/30

(52) U.S. Cl. CPC G06F 9/453; G06F 8/70; G06F 40/30

(57) ABSTRACT

A computer implemented method for autonomous data mapping during code development, the method including: receiving a support ticket, the support ticket including support ticket metadata; mapping the support ticket metadata to a first set of metadata fields in a continuous delivery platform; receiving a work item ticket including work item ticket metadata; determining a first link between the support ticket and work item ticket, wherein the first link is determined autonomously; mapping, based on the first link, the work ticket item metadata to the first set of metadata fields in the continuous delivery platform; receiving artifact metadata related to the work item ticket, the artifact metadata including a code repository link to an artifact; mapping the artifact metadata to the first set of metadata fields in the continuous delivery platform; and outputting to a user interface or database, the first set of metadata fields.

### TECHNICAL FIELD

Various embodiments of the present disclosure relate generally to managing tend-to-end visibility for code production and, more particularly, to systems and methods for autonomous data mapping during code development.

### BACKGROUND

In modern code integration and deployment systems, it may be challenging to maintain and manage end-to-end visibility from an initial request to code deployment. Issues such as missing data, inconsistent tagging, and lack of end-to-end automation may lead to issues with systems providing real time insight into project statuses, issue traceability, and release visibility across development, testing, and deployment of code.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a computer implemented method for autonomous data mapping during code development, the method including: receiving a support ticket, the support ticket including support ticket metadata; mapping the support ticket metadata to a first set of metadata fields in a continuous delivery platform; receiving a work item ticket including work item ticket metadata; determining a first link between the support ticket and work item ticket, wherein the first link is determined autonomously; mapping, based on the first link, the work ticket item metadata to the first set of metadata fields in the continuous delivery platform; receiving artifact metadata related to the work item ticket, the artifact metadata including a code repository link to an artifact; mapping the artifact metadata to the first set of metadata fields in the continuous delivery platform; and outputting to a user interface or database, the first set of metadata fields.

In some aspects, the techniques described herein relate to a method, wherein the support ticket metadata includes a client name data object, an issue description data object, a category data object, a severity data object, a priority data object, a product name data object, and a ticket number data object.

In some aspects, the techniques described herein relate to a method, further including: applying a natural language processing module to the issue description data object, to generate a first description vector; and storing the first description vector.

In some aspects, the techniques described herein relate to a method, wherein the work item ticket is a task, issue, or work item representing a specific request, bug, feature or action item to be resolved related to code deployment.

In some aspects, the techniques described herein relate to a method, further including: extracting a description field from the work item ticket metadata; preprocessing the description field; applying a natural language processing module the preprocessed description field to generate a second description vector; and storing the second description vector.

In some aspects, the techniques described herein relate to a method, wherein the determining the first link between the support ticket and work item ticket, further includes: applying a distance algorithm between a first description vector and a second description vector, the first description vector representing a data object from the support ticket metadata, and the second description vector representing a data object from the work item metadata; and determining that a distance between the first description vector and second description vector is under a threshold value.

In some aspects, the techniques described herein relate to a method 1, further including: receiving a second work item ticket with second work item ticket metadata; determining a second link between the support ticket and the second work item ticket, wherein the second link is determined autonomously; mapping, based on the second link, the second work item ticket metadata to the first set of metadata fields in the continuous delivery platform; and outputting to the user interface or database, the first set of metadata fields including the second work item ticket metadata.

In some aspects, the techniques described herein relate to a method, further including: receiving artifact metadata related to the second work item ticket; mapping the artifact metadata related to the second work item ticket to the first set of metadata fields in the continuous delivery platform; and outputting to the user interface or database, the first of set of metadata fields including the artifact metadata.

In some aspects, the techniques described herein relate to a method, wherein the artifact metadata further includes a docker image.

In some aspects, the techniques described herein relate to a system for finding historically similar incidents in a system, the system including: a memory having processor-readable instructions stored therein; and at least one processor configured to access the memory and execute the processor-readable instructions to perform operations including: receiving a support ticket, the support ticket including support ticket metadata; mapping the support ticket metadata to a first set of metadata fields in a continuous delivery platform; receiving a work item ticket including work item ticket metadata; determining a first link between the support ticket and the work item ticket, wherein the first link is determined autonomously; mapping, based on the first link, the work ticket item metadata to the first set of metadata fields in the continuous delivery platform; receiving artifact metadata related to the work item ticket, the artifact metadata including a code repository link to an artifact; mapping the artifact metadata to the first set of metadata fields in the continuous delivery platform; and outputting to a user interface or database, the first set of metadata fields.

In some aspects, the techniques described herein relate to a system, wherein the support ticket metadata includes a client name data object, an issue description data object, a category data object, a severity data object, a priority data object, a product name data object, and a ticket number data object.

In some aspects, the techniques described herein relate to a system, further including: applying a natural language processing module to the issue description data object, to generate a first description vector; and storing the first description vector.

In some aspects, the techniques described herein relate to a system, wherein the work item ticket is a task, issue, or work item representing a specific request, bug, feature or action item to be resolved related to code deployment.

In some aspects, the techniques described herein relate to a system, further including: extracting a description field from the work item ticket metadata; preprocessing the description field; applying a natural language processing module the preprocessed description field to generate a second description vector; and storing the second description vector.

In some aspects, the techniques described herein relate to a system, wherein the determining the first link between the support ticket and work item ticket, further includes: applying a distance algorithm between a first description vector and a second description vector, the first description vector representing a data object from the support ticket metadata, and the second description vector representing a data object from the work item metadata; and determining that a distance between the first description vector and second description vector is under a threshold value.

In some aspects, the techniques described herein relate to a non-transitory computer readable medium storing processor-readable instructions which, when executed by at least one processor, cause the at least one processor to perform operations including: receiving a support ticket, the support ticket including support ticket metadata; mapping the support ticket metadata to a first set of metadata fields in a continuous delivery platform; receiving a work item ticket including work item ticket metadata; determining a first link between the support ticket and the work item ticket, wherein the first link is determined autonomously; mapping, based on the first link, the work ticket item metadata to the first set of metadata fields in the continuous delivery platform; receiving artifact metadata related to the work item ticket, the artifact metadata including a code repository link to an artifact; mapping the artifact metadata to the first set of metadata fields in the continuous delivery platform; and outputting to a user interface or database, the first set of metadata fields.

In some aspects, the techniques described herein relate to a non-transitory computer readable medium, wherein the support ticket metadata includes a client name data object, an issue description data object, a category data object, a severity data object, a priority data object, a product name data object, and a ticket number data object.

In some aspects, the techniques described herein relate to a non-transitory computer readable medium, further including: applying a natural language processing module to the issue description data object, to generate a first description vector; and storing the first description vector.

In some aspects, the techniques described herein relate to a non-transitory computer readable medium, wherein the work item ticket is a task, issue, or work item representing a specific request, bug, feature or action item to be resolved related to code deployment.

In some aspects, the techniques described herein relate to a non-transitory computer readable medium, further including: extracting a description field from the work item ticket metadata; preprocessing the description field; applying a natural language processing module the preprocessed description field to generate a second description vector; and storing the second description vector.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 depicts an exemplary environment for autonomous data mapping during code development, according to one or more embodiments.

FIG. 2A depicts an exemplary flowchart for a method of mapping tickets and ticket metadata associated with code integration and deployment, according to one or more embodiments.

FIG. 2B depicts an exemplary flowchart for a method of determining a first description vector of support ticket metadata, according to one or more embodiments.

FIG. 2C depicts an exemplary flowchart for a method of determining a link between a support ticket and a work item ticket, according to one or more embodiments.

FIG. 3 depicts an exemplary flowchart for a method of mapping artifact metadata to a corresponding support ticket, according to one or more embodiments.

FIG. 4 depicts an exemplary flowchart for a method of autonomous data mapping during code development, according to one or more embodiments.

FIG. 5 illustrates a computer system for executing the techniques described herein, according to one or more embodiments of the present disclosure.

### DETAILED DESCRIPTION OF EMBODIMENTS

Various embodiments of the present disclosure relate generally to managing tend-to-end visibility for code production and, more particularly, to systems and methods for autonomous data mapping during code development.

The subject matter of the present disclosure will now be described more fully with reference to the accompanying drawings that show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

The system described herein may incorporate automated maintenance of end-to-end visibility across continuous integration (“CI”)/continuous delivery (“CD”). A CI/CD system may include a set of automated processes that allow developers to build, test, and deploy code. The CI/CD pipeline may include source code commits, build, automated test, packaging, and production deployment. The system described herein may allow for more accurate tracking and deploying of code through the production process.

In modern enterprise environments, managing end-to-end visibility from client requests to production deployments may be essential for ensuring streamlined development, operational efficiency, and superior client satisfaction. The system described herein may integrate a variety of software's such as ServiceNow, Jira/Rally, GitHub/Bitbucket, Jenkins, and Harness SEI, automating the extraction, transformation, and tracking of critical metadata and artifacts. An artifact may refer to a file or set of files produced as a result of the build process that may be needed for deployment or further stages of the pipeline. Achieving accurate visibility for external requests for code updates, to production release may be complex for a variety of issues. The system described herein may address the three primary challenges: missing data, inconsistent tagging, and automated triggers, thereby achieving accurate, comprehensive visibility across CI/CD pipelines.

Missing data issues may include key metadata such as ServiceNow ticket IDs, Jira/Rally meta tags may frequently be missing or inconsistently recorded. Inconsistent Tagging Across Platforms may refer to how an environment may implement different platforms (Jira, Rally) and varied naming/tagging conventions, leading to data inconsistencies throughout the CI/CD deployment cycle. Lack of End-to-End Automation may refer to how manual data mapping between tools, systems, and environments creates delays and increases the risk of errors in tracking deployments. These challenges may hinder the ability to provide real-time insights into project status, issue traceability, and release visibility across development, testing, and deployment stages.

One or more embodiments may include a system that may provide End-to-End Visibility. For example, the system may ensure every deployment in CI/CD pipelines can be traced back to the originating client ticket.

One or more embodiments may include a system that has metadata consistency. This may include standardized metadata extraction and tagging from all tools, including ServiceNow, Jira, Rally, GitHub, and Bitbucket.

One or more embodiments may include a system that may be fully automated. This may include implementing a fully automated pipeline that triggers updates across platforms and synchronizes data at each pipeline stage.

One or more embodiments may incorporate tool integration initial setup of APIs and configurations for improved data flow and reduced manual integration efforts. The system may implement AI/ML for me metadata extraction development to maintain consistent data tagging and reduce errors. The system may include automation and orchestration development of automation scripts to reduce manual work, and increase efficiency of components described herein (e.g., a CI/CD pipeline). The system may implement Harness software engineering insights (“SEI”) configuration initial configuration and dashboard setup to provide real-time insights and better traceability of code development.

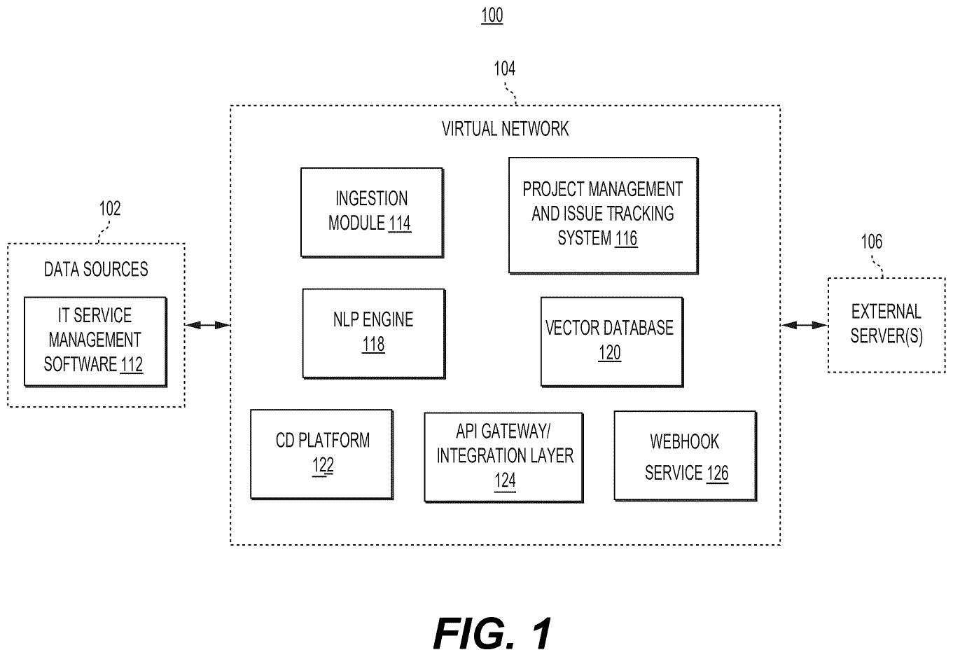

FIG. 1 depicts an exemplary environment 100 for autonomous data mapping during code development, according to one or more embodiments. The environment 100 may provide automated maintenance of end-to-end visibility across CI/CD tools by implementing one or more software. The environment 100 may include data source 102, a virtual network 104, and external servers 106. The environment 100 may be configured to interact with one or more code development and integration systems. The environment 100 may be configured to track code development through initial issue reporting to code deployment.

The data sources 102 may include an IT Service Management Software 112. The IT Service Management Software 112 may be implemented by a software such as ServiceNow (SNOW). The IT Service Management Software 112 may be configured to generate support tickets. Support tickets may be digital records used to track and manage issues, requests or inquiry reported by a user (e.g., an individual or by a system). The support tickets may be for incidents, service requests, problems, and change requests. The support tickets may include metadata describing the particular issue to which the ticket was created for. The support ticket may broadly be referred to as a client request (e.g., a client request for a problem to be fixed in software). The metadata for a support ticket may include a ticket number, a short description, a priority, an assignment group, a status, a time stamp, and any other notes/attachments.

Support tickets may be generated in the IT service Management Software 112 in a variety of ways such as through a self-service portal where forms may be submitted, through email/chat, through a virtual agent, or manually entered. In some cases, support tickets may be autogenerated by tools that monitor a system for errors. The tickets may further be assigned to a particular software/service to which the ticket applies.

The virtual network 104 may include an Ingestion Module 114, a Project Management and Issue Tracking System 116, a Natural Language Processing (“NLP”) Engine 118, a Vector Database 120, a CD Platform 122, an Application Program Interface (“API”) Gateway/Integration Layer 124, and a Webhook Service 126. Each of these may be comprised of one or more software modules. The one or more software modules may be collections of code or instructions stored on a media (e.g., memory of organization computing system 500) that represent a series of machine instructions (e.g., program code) that implements one or more algorithmic steps. Such machine instructions may be the actual computer code, the processor of organization computing system 500 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

The virtual network 104 may be configured to receive support tickets from the IT Service Management Software 112 through an Ingestion Module 114. The Ingestion Module 114 may be configured to retrieve each support ticket generated and to initiate the mapping of the support ticket. The Ingestion Module 114 may be configured to retrieve support tickets through a network that connects the data sources 102. The network may be of any suitable type, including individual connections via the Internet, such as cellular or Wi-Fi networks. In some embodiments, network may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connections may be encrypted or otherwise secured. In some embodiments, however, the information being transmitted may be less personal, and therefore, the network connections may be selected for convenience over security.

The network may include any type of computer networking arrangement used to exchange data or information. For example, network may be the Internet, a private data network, virtual private network using a public network and/or other suitable connection(s) that enables components in environment 100 to send and receive information between the components of environment 100.

The virtual network 104 may include the Project Management and Issue Tracking System 116 which may be configured to manage development issues and to link them to support tickets from the IT Service Management Software 112. The Project Management and Issue Tracking System 116 may be implemented by software such as JIRA. The Project Management and Issue Tracking System 116 may be configured to perform issue management and to track code development issues such as bugs (e.g., code defect), stories (e.g., new features or enhancement), tasks/sub-tasks (e.g., development or operational work), and/or epics (e.g., larger bodies of work grouping multiple issues). The Project Management and Issue Tracking System 116 may create a ticket, herein referred to as a “work item ticket” to track the code development. The work item ticket may include a description, assignees (e.g., coders associated with the issue), status, comments, attachments, and code inks (e.g., direct links to code). The Project Management and Issue Tracking System 116 may further be configured to link to a support ticket from the IT Service Management Software 112.

The virtual network 104 may include an NLP Engine 118 that may be configured to process ticket descriptions for vectorization and similarity matching. The NLP Engine 118 may incorporate a machine learning model.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

In some examples, the NLP Engine 118 may incorporate a software to process text from within the support tickets (e.g., from the IT Service Management Software 112) and from issues (e.g., from the Project Management and Issue Tracking System). The NLP Engine 118 may convert text to embedding utilizing a pre-trained machine learning model such as BERT. The NLP Engine 118 may include stacked transformer encoder layers. The NLP Engine 118 may include token embeddings, positional embeddings, and/or segment embeddings. The token embeddings may assign a unique vector to each token. The positional embeddings may define the position of a word within a string. The environment may further include one or more software modules configured to tokenize, remove stop works, and apply stemming/lemmatization to text prior to NLP Engine 118 analysis.

The virtual network 104 may include a Vector Database 120. The Vector Database 120 may be configured to store vectors/embeddings generated by the NLP Engine 118. The Vector Database 120 may be configured to employ techniques such as quantization, indexing, and efficient distance computation to store and process large-scale datasets. The Vector Database 120 may be configured to use vector representation of data points and to perform approximate nearest neighbor searches to find similar vectors. The Vector Database 120 may, for example, be the “Facebook AI Similarity Search” (FAISS) library.

The virtual network 104 may include a CD Platform 122 configured to display mapped metadata in the CD pipeline, linking deployments to support tickets. The CD Platform 122 may be implemented by a software such as Harness CD. The CD Platform 122 may be configured to manage the process of moving code from build to production and it may be configured to deploy applications to different environments and validate deployments.

The virtual network 104 may include API Gateway/Integration Layers 124, that may be configured to manage API calls and Webhook Service 126 processing. The Integration Layers 124 may incorporate software to allow for communication between all components of the virtual network 104 and with external servers/users/databases. The integration layers may include REST APIs, and Pub/Sub messaging systems.

The virtual network 104 may include a Webhook Service 126 configured to trigger workflows at each stage of IT Service Management Software 112, Project Management and Issue Tracking System 116, and CD Platform 122. The Webhook Service 126 may include a software application to send real-time data or notifications when particular events occur within the environment 100.

The virtual network 104 may have API configurations monitored and updated. The virtual network 104 may implement validation checks. The AI models incorporated may be regularly retrained and validated.

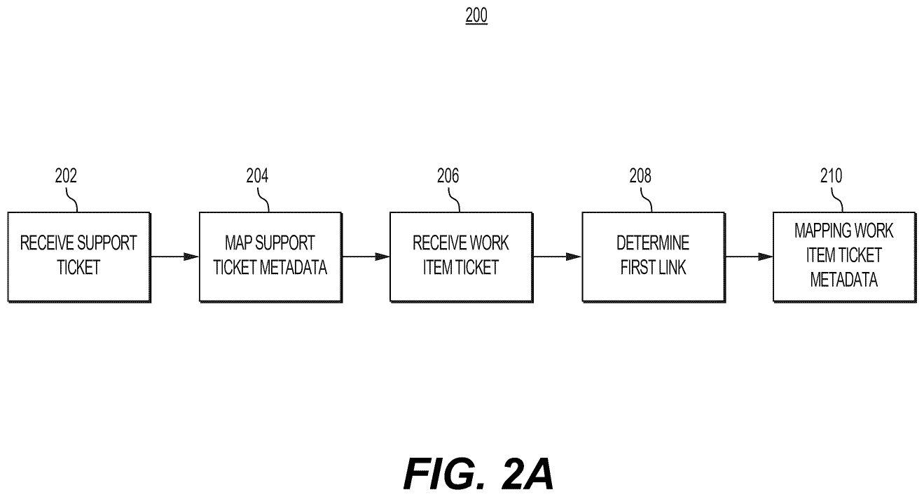

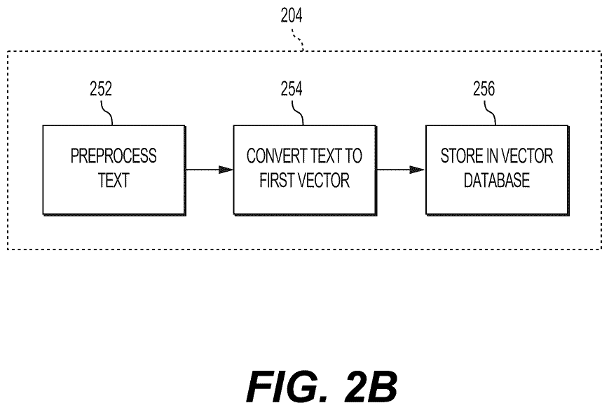

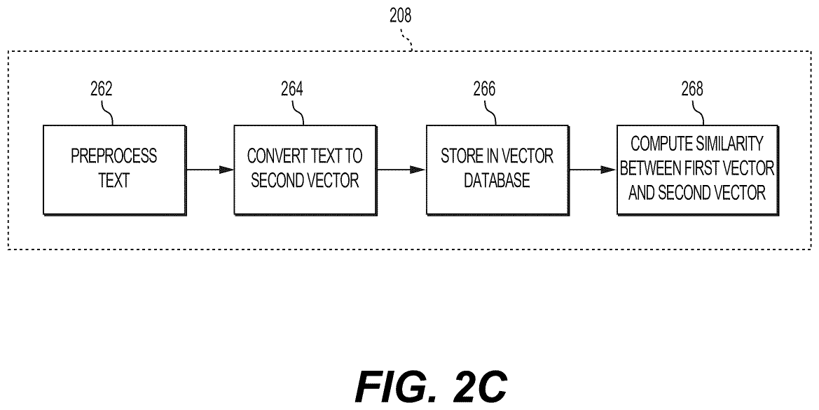

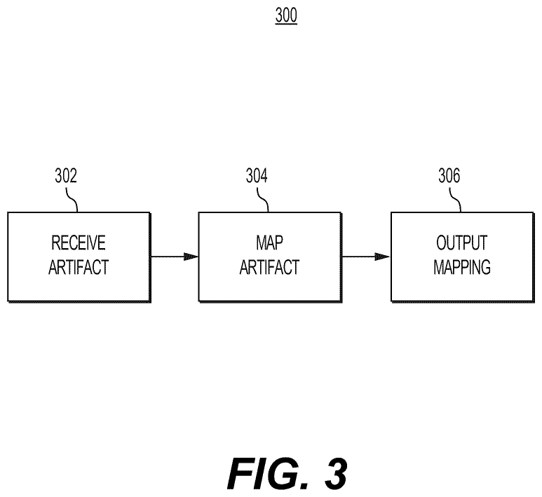

FIG. 2A depicts an exemplary flowchart for a method 200 of mapping tickets and ticket metadata associated with code integration and deployment, according to one or more embodiments. FIG. 2A and FIG. 3, when applied may together provide a method for automated maintenance of end-to-end visibility across a system for code integration and deployment, according to one or more embodiments. The method 200 described in FIG. 2A may be implemented by the environment 100 described in FIG. 1. The method of 200 may be implemented whenever a support ticket is generated by the IT Service Management Software 112 of FIG. 1.

Step 202 may include receiving a support ticket (e.g., the ingestion module 114 receiving the support ticket from the IT Service Management Software 112), the support ticket including request metadata. The support tickets may be associated with an incident, service requests, problems, and/or change requests. The request metadata may include includes a client name data object, an issue description data object, a category data object, a severity data object, a priority data object, a product name data object, and a ticket number data object. An exemplary set of request metadata may be as follows: Client Name—ABC Corp, Issue Details—“User unable to login to dashboard due to error,” Category—Login issue, severity—high, priority—critical, product name “Client Dashboard,” Ticket Number—SN12345.

In some examples, the support ticket may have been automatically generated upon an occurrence of an event such as an alert, a customer request, or a bug report. In some examples, the support ticket may be manually entered by a user. In some examples, the category may be incomplete, and an NLP model (e.g., NLP Engine 118 may be applied to determine a category during step 202).

Step 204 may include mapping the support ticket metadata to a first set of metadata fields in a CD platform (e.g., CD Platform 122). An example of the first set of metadata fields with the support ticket metadata may be:

{

“clientName”: “ACME Corp”,
“issueDescription”: “User unable to login to dashboard due to error”,
“category”: “Login Issue”,
“severity”: “High”,
“priority”: “Critical”,
“productName”: “Client Dashboard”,
“snowTicketNumber”: “SN12345”

}

Step 204 may further include determining a first description vector, wherein the first description vector is a vector of the support ticket metadata. More specifically, the first description vector may represent the Issue description data object. FIG. 2B depicts an exemplary flowchart for a method of determining a first description vector of support ticket metadata, according to one or more embodiments. The method of FIG. 2B may specifically be applied to the text field located within the issue description data object.

Step 252 may include applying a preprocessing text algorithm (e.g., one or more preprocessing text algorithms) to the text. Exemplary algorithms that may be applied include, but are not limited to, lower casing, tokenization, punctuation mark removal, stop word removal, stemming, and/or lemmatization algorithms. The lower casing algorithm may convert all uppercase characters to lower case. The tokenization algorithm may break the text (e.g., words, numbers, characters, etc.) into smaller units (e.g., tokens). The output may be a list or sequences of tokens. The punctuation mark removal algorithm may be configured to find and remove any punctuation marks from the text. The stop word removal algorithm may identify and eliminate frequently occurring words with low semantic meaning. For example, this may include the removal of words such as “a”, “the,” “is,” “in,” etc. The stemming algorithm may reduce words to their base or root form. The algorithm may remove suffixes from term (e.g., the term running may be converted to “run). The Lemmatization algorithm may reduce words to their base or dictionary form. The algorithm may lever a morphological dictionary and map inflected words to their respective lemmas. The tokenization algorithm may be the last processing algorithm applied to the received text. The punctuation and stop removal algorithms may be applied first.

Step 254 may include converting the text (e.g., the preprocessed text) of the issue description data object to a first vector. This may include applying an NLP model (e.g., the NLP Engine 118) to the text. In some examples, this may include tokenizing the text, converting a token to a specific ID, adding positional embeddings and segment embeddings, and passing the input through multiple transformer layers, and generating a first description vector of the detailed description. In some examples, each word may have a particular value assigned by the MLP model.

Step 256 may include storing the first description vector to a database (e.g., the Vector Database 120).

Step 206 may include receiving a work item ticket including work item metadata. This may be retrieved from the Project Management and Issue Tracking System 116. The work item ticket may be utilized to manage and track code development issues such as bugs (e.g., code defect), stories (e.g., new features or enhancement), tasks/sub-tasks (e.g., development or operational work), and/or epics (e.g., larger bodies of work grouping multiple issues). In some examples, the work item ticket may be generated in response to the virtual network 104 receiving a support ticket (e.g., at step 202) and may track progress for addressing the support ticket from step 202. The work item metadata may include a description filed. The description field may include text describing the code issue. The work item metadata may further include an issue type, an assigned person, and a ticket number. An example set of work item metadata may be Issue type—bug, Description—“login fails with dashboard error,” Assigned Person—John Doe, Ticket Number—JIRA-4567.

Step 208 may include determining a first link between the support ticket and work item ticket, wherein the link is determined autonomously. FIG. 2C depicts an exemplary flowchart for a method of determining a link between a support ticket and a work item ticket, according to one or more embodiments.

Step 262 may include preprocessing text, such as the description field of the work item metadata. Step 262 may include applying any of the algorithms applied at step 252.

Step 264 may include converting the text (e.g., the preprocessed text) of the description field of the work item metadata to a second vector. This may include applying an NLP model (e.g., the NLP Engine 118) to the text. Step 264 may include applying the same algorithms/techniques applied at step 254 to generate a second description vector.

Step 266 may include saving the second description vector to a database (e.g., the Vector Database 120).

Step 268 may include computing a similarity score between the first description vector and second vector description. The similarity score may define how related first description vector and second description vector are. The similarity score may be utilized to establish mappings between the support ticket and the work item ticket. In some examples, the similarity score may be computed by computing a cosine similarity algorithm between the first description vector and the second description vector. In some examples, the similarity score may be computed by applying a Euclidean distance algorithm between the first description vector and the second description vector.

In some examples, step 268 may be applied between the second description vector and with all description vectors associated with support tickets stored within the vector database. This may allow for a similarity score to be computed, comparing the work item ticket's similarity to all saved support tickets. This may allow for the work item ticket to be linked to a most similar support ticket (e.g., based on a highest similarity score).

The method may further include determining that the similarity score determined at step 268 is within a threshold value. If the similarity score is within the threshold value, then the support ticket and the work item ticket may be linked (e.g., via a first link) and considered to be related. The first link may may include the similarity score and associated support ticket and work item ticket to storage.

In an example scenario of step 208, the support ticket description may be “User unable to login to dashboard due to error. The first description vector may be: [0.45, −0.23, 0.78, . . . ]. The work item metadata description may be “Login fails with dashboard error.” The second description vector may be [0.46, −0.22, 0.76, . . . ]. A cosine similarity may be applied to the vectors to determine a similarity score that links the related tickets (e.g., the support ticket and work item ticket).

Step 210 may include mapping, based on the first link, the work item ticket metadata to the first set of metadata fields in the CD platform (e.g., CD Platform 122). An example of the workflow metadata fields being mapped to the first set of metadata fields may be:

{

“jiraIssueType”: “Bug”,
“jiraDescription”: “Login fails with dashboard error”,
“jiraAssignee”: “John Doe”,
“jiraTicketNumber”: “JIRA-4567”

}

Upon the completion of method 200, the support ticket and workflow ticket, and all corresponding metadata may be linked within CD platform will all corresponding metadata logged.

In some examples, steps 206-210 may be applied each time the Project Management and Issue Tracking System 116 generates a work item ticket. By applying the steps 206-210, for each work ticket generated, this may allow for each of the generated work tickets to be linked and mapped to a support ticket. Multiple work item tickets may be linked and mapped to a single support ticket.

FIG. 3 depicts an exemplary flowchart for a method 300 of mapping artifact metadata to a corresponding support ticket, according to one or more embodiments. The method 300 described in FIG. 3 may be implemented by the environment 100 described in FIG. 1. The method of 300 may be implemented whenever an artifact is generated by the Project management and Issue Tracking System. The method may map the artifact to associated support tickets and work item tickets in the CD Platform 122.

Step 302 may include receiving artifact metadata related to the work item ticket, the artifact metadata including a code repository link to an artifact and a docker image. The artifact metadata may include a code repository link, a branch/version, a docker image ID, and a docker tag. The code repository link may link prepared code

Step 304 may include mapping the artifact metadata to the first set of metadata fields in the CD platform (e.g., CD Platform 122).

Step 306 may include outputting to a user interface or external database, the first set of metadata fields. A summary of all metadata mapped to the CD platform may be as follows:
SNOW client_name clientName
SNOW issue_details issueDescription
SNOW severity severity
SNOW priority priority
SNOW product_name productName
SNOW ticket_number snowTicketNumber
JIRA issue_type jiralssueType
JIRA description jiraDescription
JIRA assigned_person jiraAssignee
JIRA ticket_number jiraTicketNumber
Codebase repository link codeRepoLink
Codebase branch/version codeBranch
Docker image ID dockerImageID
Docker image version/tag dockerVersion

An example of a CD platform, with associated metadata may be as follows:

{

“clientName”: “ACME Corp”,
“issueDescription”: “User unable to login to dashboard due to error”,
“severity”: “High”,
“priority”: “Critical”,
“productName”: “Client Dashboard”,
“snowTicketNumber”: “SN12345”,
“jiraIssueType”: “Bug”,
“jiraAssignee”: “John Doe”,
“jiraTicketNumber”: “JIRA-4567”,
“codeRepoLink”: “https://repo.example.com/project”,
“codeBranch”: “release-1.0”,
“dockerImageID”: “img456”,
“dockerVersion”: “v1.0”

}

The method of 200 and 300 may include automated workflows based on updates to the IT Service Management Software 112, the Project Management and Issue Tracking System 116, and the CD Platform 122. The virtual network 104 may implement Webhook Services 126 to trigger the methods and perform mapping within the CD Platform 122. For example, the Webhook Services 126 may include a webhook for each of the IT Service Management Software 112, the Project Management and Issue Tracking System 116, and the CD Platform 122. The Webhook Endpoint for the IT Service Management Software 112 (e.g., SNOW Webhook) may trigger method 200 upon the creation or update of a ticket. The Webhook Endpoint for the Project Management and Issue Tracking System 116 (e.g., JIRA Webhook) may trigger steps 206-210 of method 200 when a work item ticket is created or updated. The Webhook Endpoint for the CD Platform 122 (e.g., Harness Webhook) may trigger pipeline execution. Below may be exemplary webhooks implemented in the Webhook Services 126.

### The Snow Webhook Payload:

{

“client_name”: “ACME Corp”,
“issue_details”: “User unable to login to dashboard due to error”,
“category”: “Login Issue”,
“severity”: “High”,
“priority”: “Critical”,
“ticket_number”: “SN12345”

}

### The JIRA Webhook Payload:

{

“issue_type”: “Bug”,
“description”: “Login fails with dashboard error”,
“assigned_person”: “John Doe”,
“ticket_number”: “JIRA-4567”

}

### The Harness Webhook Payload:

{

“deployment_id”: “deploy123”,
“snow_ticket_number”: “SN12345”,
“jira_ticket_number”: “JIRA-4567”,
“docker_image_id”: “img456”,
“code_branch”: “release-1.0”

}

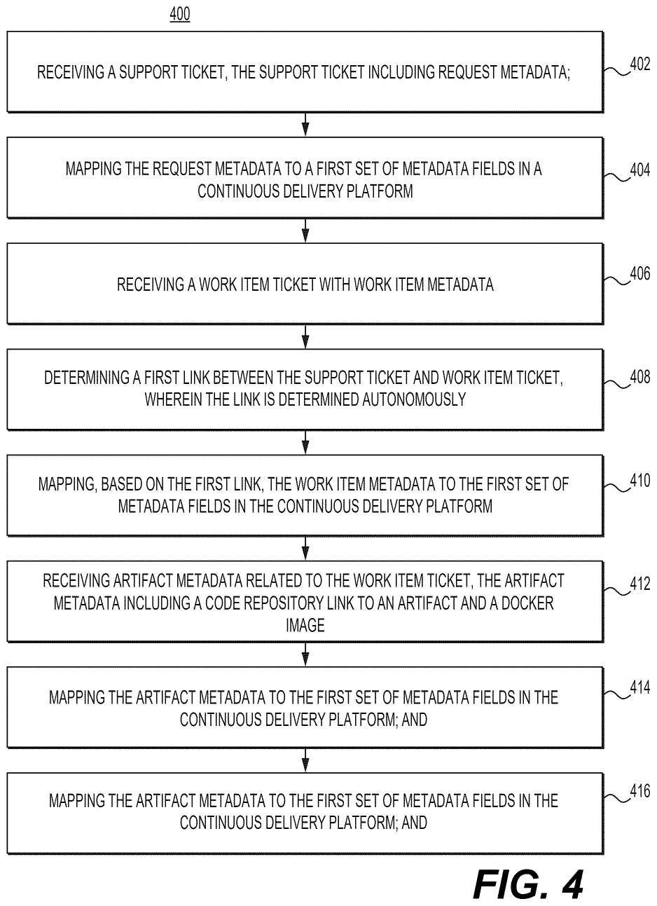

FIG. 4 depicts an exemplary flowchart for a method 400 of autonomous data mapping during code development, according to one or more embodiments. The method 400 described in FIG. 4 may be implemented by the environment 100 described in FIG. 1.

Step 402 may include receiving a support ticket, the support ticket including support ticket metadata. The support ticket metadata may include a client name data object, an issue description data object, a category data object, a severity data object, a priority data object, a product name data object, and a ticket number data object.

Step 404 may include mapping the support ticket metadata to a first set of metadata fields in a continuous delivery platform.

The method may further include applying a natural language processing module to the issue description data object, to generate a first description vector; and storing the first description vector.

Step 406 may include receiving a work item ticket including work item ticket metadata. The work item ticket may be a task, issue, or work item representing a specific request, bug, feature or action item to be resolved related to code deployment.

The method may further include extracting a description field from the work item ticket metadata; preprocessing the description field; applying a natural language processing module the preprocessed description field to generate a second description vector; and storing the second description vector.

Step 408 may include determining a first link between the support ticket and work item ticket, wherein the first link is determined autonomously. Determining this link may include applying a distance algorithm between a first description vector and a second description vector, the first description vector representing a data object from the support ticket metadata, and the second description vector representing a data object from the work item metadata; and determining that a distance between the first description vector and second description vector is under a threshold value.

Step 410 may include mapping, based on the first link, the work ticket item metadata to the first set of metadata fields in the continuous delivery platform.

The method may further include receiving a second work item ticket with second work item ticket metadata; determining a second link between the support ticket and the second work item ticket, wherein the second link is determined autonomously; mapping, based on the second link, the second work item ticket metadata to the first set of metadata fields in the continuous delivery platform; and outputting to the user interface or database, the first set of metadata fields including the second work item ticket metadata.

Step 412 may include receiving artifact metadata related to the work item ticket, the artifact metadata including a code repository link to an artifact. The artifact metadata may include a docker image.

Step 414 may include mapping the artifact metadata to the first set of metadata fields in the continuous delivery platform.

The method may include receiving artifact metadata related to the second work item ticket; mapping the artifact metadata related to the second work item ticket to the first set of metadata fields in the continuous delivery platform; and

Step 416 may include outputting to a user interface or database, the first set of metadata fields. This

Advantageously, the system described herein may be configured to automatically extract key information from support tickets and work items tickets by implementing API and NLP, and mapping the metadata fields in the CD Platform 122. The system may be configured to perform NLP vectorization for textual similarity analysis, where NLP vectorization is applied to descriptive fields of tickets (e.g., issue descriptions) to establish mapping between support tickets and work item tickets based on text similarity. Further, the system may implement webbooks to tripper automatic workflows upon updates to the IT Service Management Software 112, the Project Management and Issue Tracking System 116, and the CD Platform 122. This may allow for the methods described in FIGS. 2A and 3 to be implemented automatically upon the updates to the respective modules. Lastly, the system may be configured to map docker and code artifacts and deployment metadata to a CD Platform.

The system may integrate tool to provide improved data flow to reduce manual integration efforts. The techniques may provide for consistent data tagging with few errors. The system may further integrate automation and orchestration development of automation scripts with reduced manual work and an efficient CI/CD. The CD Platform 122 may provide real-time insights, better traceability by outputting links and associated metadata to users through a user interface.

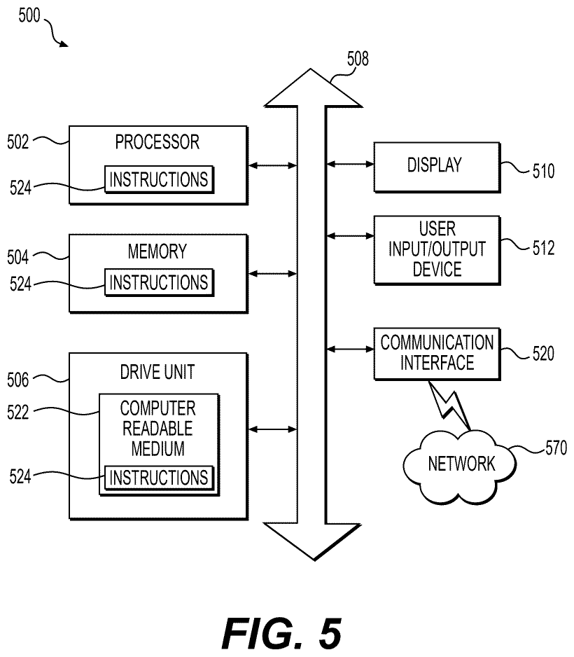

As illustrated in FIG. 5, the computer system 500 may include a processor 502, e.g., a central processing unit (CPU), a graphics processing unit (GPU), or both. The processor 502 may be a component in a variety of systems. For example, the processor 502 may be part of a standard personal computer or a workstation. The processor 502 may be one or more general processors, digital signal processors, application specific integrated circuits, field programmable gate arrays, servers, networks, digital circuits, analog circuits, combinations thereof, or other now known or later developed devices for analyzing and processing data. The processor 502 may implement a software program, such as code generated manually (i.e., programmed).

The computer system 500 may include a memory 504 that can communicate via a bus 508. The memory 504 may be a main memory, a static memory, or a dynamic memory. The memory 504 may include but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 504 includes a cache or random-access memory for the processor 502. In alternative implementations, the memory 504 is separate from the processor 502, such as a cache memory of a processor, the system memory, or other memory. The memory 504 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 504 is operable to store instructions executable by the processor 502. The functions, acts or tasks illustrated in the figures or described herein may be performed by the programmed processor 502 executing the instructions stored in the memory 504. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel payment and the like.

As shown, the computer system 500 may further include a display unit 510, such as a liquid crystal display (LCD), an organic light emitting diode (OLED), a flat panel display, a solid-state display, a cathode ray tube (CRT), a projector, a printer or other now known or later developed display device for outputting determined information. The display unit 510 may act as an interface for the user to see the functioning of the processor 502, or specifically as an interface with the software stored in the memory 504 or in a disk or optical drive unit 506.

Additionally, or alternatively, the computer system 500 may include a user input/output device 512 configured to allow a user to interact with any of the components of computer system 500. The input/output device 512 may be a number pad, a keyboard, or a cursor control device, such as a mouse, or a joystick, touch screen display, remote control, or any other device operative to interact with the computer system 500.

The disk drive unit 506 may include a computer-readable medium 522 in which one or more sets of instructions 524, e.g., software, can be embedded. Further, the instructions 524 may embody one or more of the methods or logic as described herein. The instructions 524 may reside completely or partially within the memory 504 and/or within the processor 502 during execution by the computer system 500. The memory 504 and the processor 502 also may include computer-readable media as discussed above.

In some systems, a computer-readable medium 522 includes instructions 524 or receives and executes instructions 524 responsive to a propagated signal so that a device connected to a network 570 can communicate voice, video, audio, images, or any other data over the network 570. Further, the instructions 524 may be transmitted or received over the network 570 via a communication port or interface 520, and/or using a bus 508. The communication port or interface 520 may be a part of the processor 502 or may be a separate component. The communication port 520 may be created in software or may be a physical connection in hardware. The communication port 520 may be configured to connect with a network 570, external media, the display unit 510, or any other components in computer system 500, or combinations thereof. The connection with the network 570 may be a physical connection, such as a wired Ethernet connection or may be established wirelessly as discussed below. Likewise, the additional connections with other components of the computer system 500 may be physical connections or may be established wirelessly. The network 570 may be directly connected to the bus 508.

While the computer-readable medium 522 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 522 may be non-transitory and may be tangible.

The computer-readable medium 522 can include a solid-state memory such as a memory card or other package that houses one or more non-volatile read-only memories. The computer-readable medium 522 can be a random-access memory or other volatile re-writable memory. Additionally, or alternatively, the computer-readable medium 522 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 500 may be connected to one or more networks 570. The network 570 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including but not limited to TCP/IP based networking protocols. The network 570 may include wide area networks (WAN), such as the Internet, local area networks (LAN), campus area networks, metropolitan area networks, a direct connection such as through a Universal Serial Bus (USB) port, or any other networks that may allow for data communication. The network 570 may be configured to couple one computing device to another computing device to enable communication of data between the devices. The network 570 may generally be enabled to employ any form of machine-readable media for communicating information from one device to another. The network 570 may include communication methods by which information may travel between computing devices. The network 570 may be divided into sub-networks. The sub-networks may allow access to all of the other components connected thereto or the sub-networks may restrict access between the components. The network 570 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel payment. Alternatively, virtual computer system processing can be constructed to implement one or more of the methods or functionalities as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP, etc.) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments, various features of the embodiments are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that a claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some, but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the function.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer implemented method for autonomous data mapping during code development, the method comprising:
receiving a support ticket, the support ticket including support ticket metadata;
mapping the support ticket metadata to a first set of metadata fields in a continuous delivery platform;
receiving a work item ticket including work item ticket metadata;
determining a first link between the support ticket and work item ticket, wherein the first link is determined autonomously;
mapping, based on the first link, the work ticket item metadata to the first set of metadata fields in the continuous delivery platform;
receiving artifact metadata related to the work item ticket, the artifact metadata including a code repository link to an artifact;
mapping the artifact metadata to the first set of metadata fields in the continuous delivery platform; and
outputting to a user interface or database, the first set of metadata fields.

2. The method of claim 1, wherein the support ticket metadata includes a client name data object, an issue description data object, a category data object, a severity data object, a priority data object, a product name data object, and a ticket number data object.

3. The method of claim 2, further including:
applying a natural language processing module to the issue description data object, to generate a first description vector; and
storing the first description vector.

4. The method of claim 1, wherein the work item ticket is a task, issue, or work item representing a specific request, bug, feature or action item to be resolved related to code deployment.

5. The method of claim 1, further including:
extracting a description field from the work item ticket metadata;
preprocessing the description field;
applying a natural language processing module the preprocessed description field to generate a second description vector; and
storing the second description vector.

6. The method of claim 1, wherein the determining the first link between the support ticket and work item ticket, further includes:
applying a distance algorithm between a first description vector and a second description vector, the first description vector representing a data object from the support ticket metadata, and the second description vector representing a data object from the work item metadata; and
determining that a distance between the first description vector and second description vector is under a threshold value.

7. The method of claim 1, further including:
receiving a second work item ticket with second work item ticket metadata;
determining a second link between the support ticket and the second work item ticket, wherein the second link is determined autonomously;
mapping, based on the second link, the second work item ticket metadata to the first set of metadata fields in the continuous delivery platform; and
outputting to the user interface or database, the first set of metadata fields including the second work item ticket metadata.

8. The method of claim 7, further including:
receiving artifact metadata related to the second work item ticket;
mapping the artifact metadata related to the second work item ticket to the first set of metadata fields in the continuous delivery platform; and
outputting to the user interface or database, the first of set of metadata fields including the artifact metadata.

9. The method of claim 1, wherein the artifact metadata further includes a docker image.

10. A system for finding historically similar incidents in a system, the system comprising:
a memory having processor-readable instructions stored therein; and
at least one processor configured to access the memory and execute the processor-readable instructions to perform operations including:
receiving a support ticket, the support ticket including support ticket metadata;
mapping the support ticket metadata to a first set of metadata fields in a continuous delivery platform;
receiving a work item ticket including work item ticket metadata;
determining a first link between the support ticket and the work item ticket, wherein the first link is determined autonomously;
mapping, based on the first link, the work ticket item metadata to the first set of metadata fields in the continuous delivery platform;
receiving artifact metadata related to the work item ticket, the artifact metadata including a code repository link to an artifact;
mapping the artifact metadata to the first set of metadata fields in the continuous delivery platform; and
outputting to a user interface or database, the first set of metadata fields.

11. The system of claim 10, wherein the support ticket metadata includes a client name data object, an issue description data object, a category data object, a severity data object, a priority data object, a product name data object, and a ticket number data object.

12. The system of claim 11, further including:
applying a natural language processing module to the issue description data object, to generate a first description vector; and
storing the first description vector.

13. The system of claim 10, wherein the work item ticket is a task, issue, or work item representing a specific request, bug, feature or action item to be resolved related to code deployment.

14. The system of claim 10, further including:
extracting a description field from the work item ticket metadata;
preprocessing the description field;
applying a natural language processing module the preprocessed description field to generate a second description vector; and
storing the second description vector.

15. The system of claim 10, wherein the determining the first link between the support ticket and work item ticket, further includes:
applying a distance algorithm between a first description vector and a second description vector, the first description vector representing a data object from the support ticket metadata, and the second description vector representing a data object from the work item metadata; and
determining that a distance between the first description vector and second description vector is under a threshold value.

16. A non-transitory computer readable medium storing processor-readable instructions which, when executed by at least one processor, cause the at least one processor to perform operations including:
receiving a support ticket, the support ticket including support ticket metadata;
mapping the support ticket metadata to a first set of metadata fields in a continuous delivery platform;
receiving a work item ticket including work item ticket metadata;
determining a first link between the support ticket and the work item ticket, wherein the first link is determined autonomously;
mapping, based on the first link, the work ticket item metadata to the first set of metadata fields in the continuous delivery platform;
receiving artifact metadata related to the work item ticket, the artifact metadata including a code repository link to an artifact;
mapping the artifact metadata to the first set of metadata fields in the continuous delivery platform; and
outputting to a user interface or database, the first set of metadata fields.

17. The non-transitory computer readable medium of claim 16, wherein the support ticket metadata includes a client name data object, an issue description data object, a category data object, a severity data object, a priority data object, a product name data object, and a ticket number data object.

18. The non-transitory computer readable medium of claim 17, further including:
applying a natural language processing module to the issue description data object, to generate a first description vector; and
storing the first description vector.

19. The non-transitory computer readable medium of claim 16, wherein the work item ticket is a task, issue, or work item representing a specific request, bug, feature or action item to be resolved related to code deployment.

20. The non-transitory computer readable medium of claim 16, further including:
extracting a description field from the work item ticket metadata;
preprocessing the description field;
applying a natural language processing module the preprocessed description field to generate a second description vector; and
storing the second description vector.
